(19) United States
(12) Patent Application Publication
(10) Pub. No.: US 2026/0239333 A1
(43) Pub. Date: Aug. 13, 2026

(54) METHODS FOR UPLINK CONTROL SCHEDULING

(71) Applicant: InterDigital Patent Holdings, Inc., Wilmington, DE (US)

(72) Inventors: Paul Marinier, Brossard (CA); Ghyslain Pelletier, Montreal (CA); Faris Alfarhan, Montreal (CA); Remun Koirala, London (GB); Aata El Hamss, Laval (CA); Nazli Khan Beigi, Longueuil (CA); Moon IL Lee, Melville, NY (US); Patrick Svedman, Stockholm (SE); Tao Deng, New York, NY (US); Samuli Turtinen, Ii (FI)

(73) Assignee: InterDigital Patent Holdings, Inc., Wilmington, DE (US)

(21) Appl. No.: 19/053,194

(22) Filed: Feb. 13, 2025

(51) Int. Cl. H04W 72/1268; H04B 7/06; H04L 5/00; H04W 52/36

(52) U.S. Cl. CPC H04W 72/1268; H04B 7/0626; H04L 5/0055; H04W 52/365

(57) ABSTRACT

Described herein are one or more methods, systems, and/or devices for uplink control transmission. A wireless transmit receive unit (WTRU) may determine to generate uplink control information (UCI), and may subsequently send to a network entity, for example. In some cases, the UCI may be configured by the network and may also be triggered by the network.

### BACKGROUND

In multiple situations of wireless communication systems, there are devices communicating with other devices and/or a network. Downlink transmissions include messages that are sent to the devices, and uplink transmission include messages sent from the devices. In some cases, it may be necessary to configure the transmission of uplink control information in order to avoid overhead and/or to make existing processes more efficient.

### SUMMARY

Described herein are one or more methods, systems, and/or devices for uplink control transmission. A wireless transmit receive unit (WTRU) may determine to generate uplink control information (UCI), and may subsequently send to a network entity, for example. In some cases, the UCI may be configured by the network and may also be triggered by the network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of different encoding approaches;

FIG. 3 illustrates an example process of sending uplink control information; and

FIG. 4 illustrates an example process of sending uplink control information.

### DETAILED DESCRIPTION

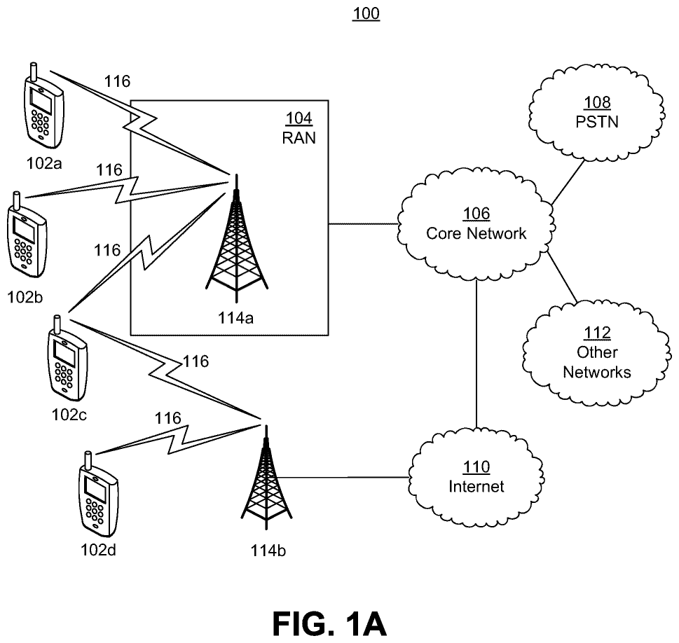

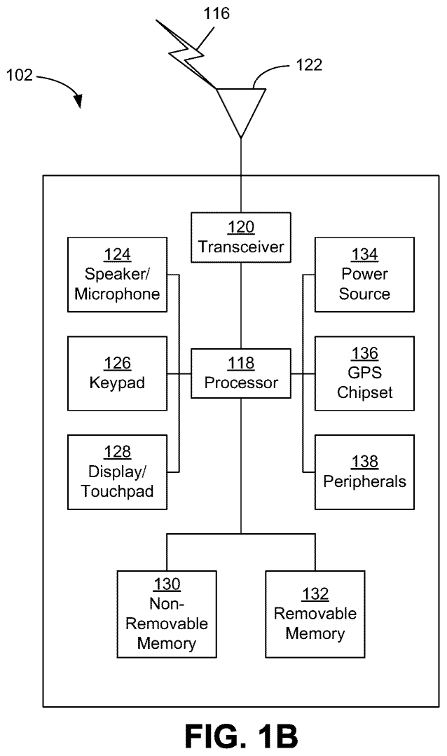

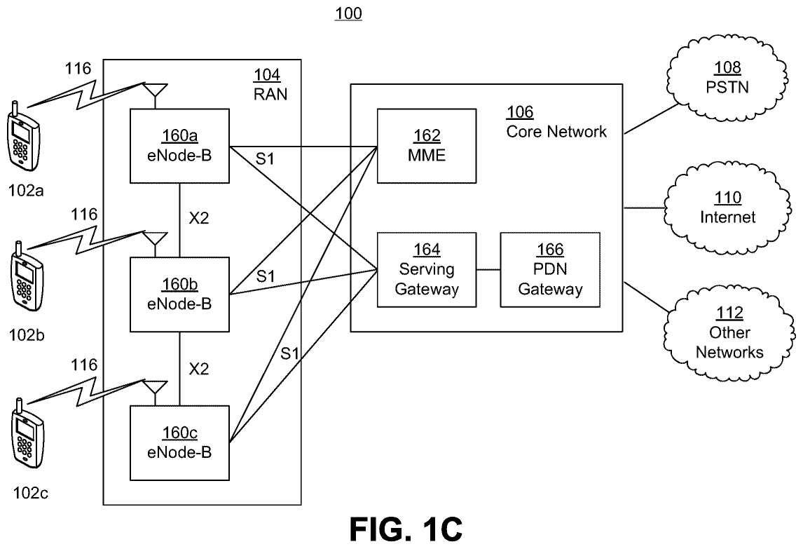

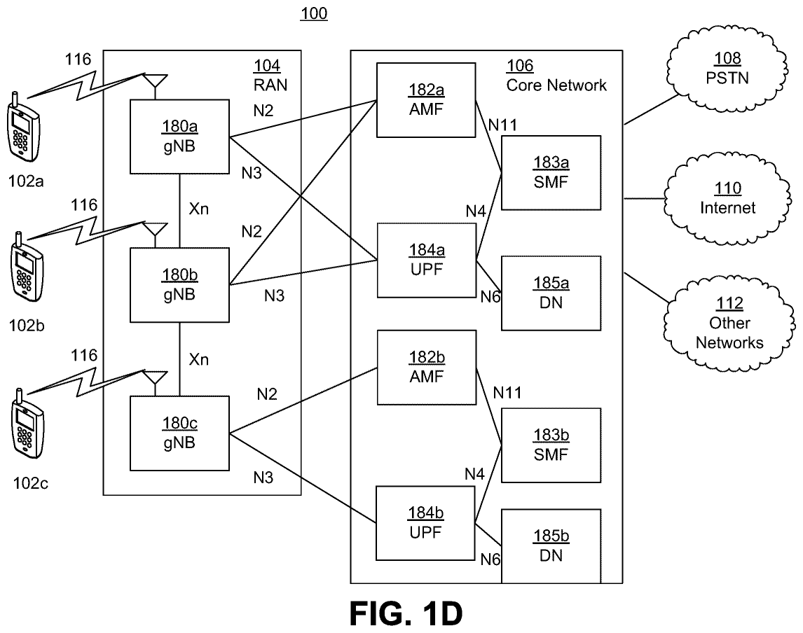

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In Long-term evolution (LTE) and New Radio (NR) wireless systems, a WTRU may transmit uplink control information (UCI). This information may include but is not limited to, for example, channel state information (CSI), scheduling request (SR), and/or HARQ-ACK feedback. The WTRU may transmit one or more types of UCI over a physical channel, such as a physical uplink control channel (PUCCH) resource that may be configured semi-statically or indicated by control configuration, such as a downlink control information (DCI). If the PUCCH resource would overlap with other PUCCH resource(s) or a physical uplink shared channel (PUSCH) resource, the WTRU may multiplex together different types of UCI and/or data into a single resource, such as PUCCH or PUSCH resource, according to specified rules.

In some situations, UCI scheduling framework used in specific circumstances (e.g., NR) may result in several limitations and/or issues. For example, various PUCCH transmissions corresponding to different types of UCI as well as PUSCH transmissions are scheduled at different times. When there is overlap in time between two or more of these transmissions, the WTRU needs to determine how to multiplex the information into a single resource. In NR, for example, each transmission's duration and start time is flexible, which means that the number of possible overlap scenarios to handle is very large, resulting in high complexity from both the perspectives of the WTRU and network, and poor potential for extensibility to other types of UCI. Timeline conditions are specified to ensure that the WTRU has sufficient time to combine the information, which restricts network flexibility.

Furthermore, in some circumstances, there may be a limitation/issue where a UCI scheduling framework may not generally enable retransmissions for UCI. This means that the network may need to conservatively set coding rates to ensure successful reception in one transmission with very high probability, which is not resource efficient.

In order to address these limitations/issues, and/or to generally improve the state of the art in one or more approaches described herein, there is a need for methods, systems, and devices to handle the transmission of uplink control information in an efficient manner. The approaches herein may help simplify the workload/overhead for WTRU and network implementation by enabling the multiplexing of selected elements of information (e.g., control, data) from a single instance of scheduling instead of multiple instances received at different times. The approaches herein may also enable retransmission of uplink control information for higher reliability with better resource efficiency.

As discussed herein, uplink control information may include any type of control information transmitted from the WTRU for the purpose of informing a scheduling entity (e.g. a network element such as a base station, another WTRU, another network entity, etc.) about conditions such as channel conditions, measurements, decoding status, transmission power, available data or control information, processing, and/or the like.

For example, UCI may include one or more of, but not limited to, the following types of information that may be separately encoded in a channel (e.g., a PUCCH or PUSCH in some systems, or equivalent other channels, etc.): Channel state information (CSI); Decoding status of PDSCH (HARQ-ACK) or PDCCH; Configured grant information (e.g., HARQ process number, redundancy version, new data indicator); Unused transmission occasion; Scheduling request; and/or, Link recovery request.

A WTRU may generate UCI at specific times depending on the type of UCI. For example, the WTRU may generate HARQ-ACK information upon attempting to decode a downlink physical channel (e.g., PDSCH).

For example, the WTRU may generate channel state information (CSI) upon receiving signaling from the network requesting measurement of CSI resources, periodically, upon activation of a transmission configuration indication (TCI) state, upon change of indicated TCI state, upon receiving signaling indicating handover or cell switch or determining a condition triggering handover or cell switch, upon measuring or reporting measurement results satisfying one or more condition(s), upon beam failure detection or recovery, upon switching to a different bandwidth part or carrier, upon activating a serving cell or carrier, upon detection of a signal such as a low-power wake-up signal, when data becomes available for transmission, when receiving data, when receiving an indication or triggering a RACH procedure or transmission, and/or when moving to a position within a new zone.

For example, the WTRU may generate power headroom information periodically, when path loss has changed by more than a threshold since the last calculation or last reporting, after activating a serving cell or carrier, upon switching to a different bandwidth part or carrier, when an uplink duty cycle exceeds a threshold, when the WTRU changes power class, when a maximum power reduction is equal or larger than a threshold, and/or has changed by more than a threshold since the last calculation or last reporting.

UCI may also include one or more of, but not limited to, the following information that is transmitted in a MAC control element (MAC CE) (e.g., in legacy systems, newer systems, etc.): an identity of the WTRU such as C-RNTI or a temporary C-RNTI; Buffer status; Configured grant confirmation; Delay status; Power headroom; Beam failure; information; Listen-before-talk failure; Positioning measurement gap activation/deactivation request; Number of desired guard symbols; Timing request; and/or, Recommended bit rate query.

UCI may also include one or more of, but not limited to, the following information: Information from receiving downlink transmission, such as soft-HARQ for PDSCH; Indication of availability of UCI; New data indicator; and/or, Separately encoded unit information or format.

The WTRU may generate UCI at specific times depending on the type of UCI. For example, the WTRU may generate HARQ-ACK information upon attempting to decode a downlink physical channel (e.g., PDSCH) or generate channel state information (CSI) upon receiving signaling from the network requesting measurement of CSI resources. The WTRU may store generated UCI in an uplink control entity(UCE) for future transmission or may immediately multiplex the UCI in a physical channel for transmission (e.g., UCE may be an entity within the WTRU and/or at the network; e.g., a UCE may be similar to a HARQ entity). The WTRU may discard UCI from the UCE when some condition occurs, such as after multiplexing the UCI in a resource, in a transport block, and/or when the UCI becomes invalid or stale.

As described herein, “UCI instance” may be used to refer to UCI characterized by one or more of, but not limited to, the following: UCI of a certain type or sub-type (e.g. HARQ-ACK, CSI, CSI part 2); UCI requested or triggered by a certain event (e.g., explicit request, PDSCH reception); UCI applicable to a certain aspect (e.g., a CSI configuration, a UCI configuration, a HARQ process, a serving cell, a PDSCH, a slot, a symbol); UCI available for transmission (e.g., not already transmitted); number of information bits or octets; an identifier of the UCI instance; an identifier of a UCI process to which the UCI instance is associated; an associated time; and/or, a deadline (maximum time) for the transmission. The associated time may be one or more of, but not limited to, the following: The time a UCI calculation (e.g. CSI calculation or HARQ-ACK calculation) was requested or triggered; The timing of a CSI resource used for CSI calculation, or of a CSI reference resource; The time applicable to a predicted CSI; The time related to reception of a corresponding PDCCH or PDSCH, e.g., for HARQ-ACK; the time of the event or signaling triggering the calculation of the UCI instance; and/or, whether the UCI was determined before or after an event such as bandwidth part switching, cell switch, activation/deactivation of resource or serving cell, beam failure recovery, radio link failure, re-establishment, and the like. The deadline (maximum time) for the transmission may be referred to as an associated time as per the above. For example, the deadline may be a time offset later than the associated time. For a UCI instance comprised of multiple components, the time offset may be specific to each component. The value of each time offset may be configured by MAC or RRC signaling.

In some instances, the WTRU may include or append information on at least one of the above characteristics to a set of at least one UCI instance prior to encoding and transmitting. For example, the WTRU may include the information in a MAC CE.

If the WTRU stores UCI in an UCI entity, the WTRU may store UCI instances on a first-in, first-out basis for a UCI process assigned to the UCI instance. The WTRU may discard a UCI instance (or component thereof) from the UCI entity when the applicable deadline has passed, upon explicit indication from the network, during certain MAC or RRC procedures (e.g., reset), and/or after multiplexing for transmission in a resource.

As described herein, a physical uplink channel may include one or more of, but not limited to, the following: a physical channel specifically designed for the transmission of control information (such as PUCCH in legacy system); and/or, physical channel designed for the transmission of higher-layer data and/or control information such as PUSCH in legacy system.

The physical uplink channel may support multiple formats, wherein each format may have a specific range of payload, number of OFDM symbols, placement of demodulation reference signals, encoding scheme, mapping to resources, and/or the like. The physical uplink channel and at least one property thereof may be indicated in a message from a network entity, such as in control in formation by downlink control information (DCI), by MAC, or configured by RRC.

As described herein, the term “uplink resource” is used to refer to an instance of a physical uplink channel over which a UCI transmission is supported. A resource, generally, may represent time(s) and/or frequency(ies).

A physical uplink channel may support transmission of one or more separately encoded units (SEU), wherein each unit may be decoded independently of other units. For example, an SEU may include one or more of, but not limited to, the following: a code block or set of code blocks encoding data from higher layers (e.g., MAC PDU or transport block), possibly including UCI included in MAC CE and/or higher-layer data; and/or, a code block or set of code blocks or set of coded bits encoding uplink control information.

For example, in legacy systems, a first SEU may include code blocks encoding data from a transport block, a second SEU may include coded bits for HARQ-ACK information, a third SEU may include coded bits for CSI part 1 information, etc.

An SEU may encode up to a maximum number of information bits or maximum payload size. For example, for an SEU encoding data from higher layers, the maximum payload size may correspond to a transport block size or MAC PDU size. The WTRU may determine or infer a maximum payload size for an SEU based on signaling associated with the uplink resource. For example, the maximum payload size may depend on at least a maximum coding rate. For example, the maximum payload size may depend on at least a modulation scheme, a target coding rate, and/or a number of resource elements available for the resource or the SEU.

For a given physical uplink channel transmission, one or more of, but not limited to, the following aspects may be specific to a SEU: Number of information bits (payload size), and/or maximum thereof; Number of coded bits; Coding rate, and/or maximum thereof; Number of coded modulation symbols per layer (i.e., spatial layer); Modulation; Resource mapping (e.g., set of layers, resource blocks, resource elements, time symbols); and/or, an identity of the SEU.

As described herein, the term “SEU information” may be used to refer to any of the aspects described herein or to any parameter that may be used to determine such aspects. For example, multiplexing information may include a set of “beta_offset” values that may be used in some systems for determining the number of coded modulation symbols per layer for a type of UCI when multiplexed in a PUSCH.

For a UCI transmission, one or more UCI instances may need to be selected based on one or more criteria. This may be applicable to the selection of UCI instances for transmission on the uplink resource or for encoding within a specific SEU of the uplink resource. This may be applicable to the initial transmission of a UCI instance and/or to a retransmission of a UCI instance. The one more criteria may relate to parameters further described herein, such as, but not limited to: priority level (e.g., select UCI instances of a specific priority level); time aspect (e.g., after/before reference time, last time, shortest time, etc.); certain UCI processes; resource restriction; and/or the like. The selection process may be configured by a network entity, and/or may be determined at the WTRU.

For one of the criteria, a WTRU may select a UCI instance based on its associated priority level or based on its highest associated priority level, in case the UCI instance has multiple associated priority levels.

For example, a WTRU may select UCI instances by order of priority until the maximum payload of the SEU (e.g., a transport block size) would be exceeded.

For example, the WTRU may execute a logical channel prioritization procedure wherein prioritization takes place across UCI instances and data from logical channels. The WTRU may then prioritize a UCI instance or a logical channel or QoS flow of first priority level over a UCI instance or a logical channel or QoS flow of second priority level, if the first priority level is higher than the second priority level.

For example, a UCI instance priority may be compared with the priority of other UCI instances, other data buffered from user plane data channels, other MAC CEs, and/or other control plane data (e.g., SRBs). The WTRU may be predefined with prioritization and multiplexing rules to determine the transmission priority of a given UCI instance over other data, other MAC CEs, and/or other UCI instances.

For example, the WTRU may select UCI instances with a priority level equal, or higher or equal than, a reference priority level. The WTRU may determine a reference priority level applicable to the uplink resource or the SEU based on receiving indication from a DCI (e.g., the DCI scheduling the transmission), MAC CE, or RRC. For example, a reference priority level may be configured as part of a semi-static configuration for the uplink resource. Alternatively, a reference priority level may be configured or pre-defined for each SEU according to an SEU identity.

For one of the criteria, a WTRU may select a UCI instance based on a time aspect associated with the UCI instance.

For example, a WTRU may select UCI instances with an associated time later than a reference time. For example, the WTRU may only a select CSI for which the CSI reference time is not earlier than the reference time. In another example, the WTRU may only select UCI instances corresponding to predicted CSI if the time to which the prediction applies is not earlier than the reference time.

The reference time may be relative to a time of the uplink resource that would encode the UCI instances (e.g., a first symbol of the uplink resource) or a time of the transmission scheduling it (e.g., a last symbol of the scheduling PDCCH). For example, the reference time may be one of such a transmission time minus an offset. The offset may be indicated by DCI, MAC CE, and/or configured by RRC.

For one of the criteria, a WTRU may select or prioritize available UCI instances with a latest associated time. For example, if multiple UCI instances correspond to CSI reports of the same CSI report configuration but different timing for the CSI reference resource, the WTRU may prioritize the available CSI report with the latest CSI reference resource. The WTRU may discard available CSI reports with earlier CSI reference resources.

For one of the criteria, a WTRU may select or prioritize available UCI instances for which the time before deadline is the shortest.

For one of the criteria, a WTRU may select a UCI instance based on a UCI process or an SEU identity to which the UCI instance is assigned or based on the corresponding UCI type.

For example, the DCI scheduling the uplink resource may include at least one UCI process identity or UCI type identity, possibly for each SEU of the transmission. The WTRU may then select UCI instances from the indicated UCI process(es) and/or UCI type(s) for encoding in respective SEUs.

For example, if an SEU identity was associated with a UCI instance, the WTRU may select the UCI instance for encoding in the corresponding SEU if such SEU is available in the transmission. The WTRU may determine if the SEU is available based on the DCI scheduling the transmission or based on semi-static signaling configuring the transmission.

For one of the criteria, a WTRU may select a UCI instance(s) based on a resource restriction. A UCI instance may be (e.g., configured) associated with a resource restriction, such that multiplexing of the UCI instance to a resource is only allowed if the resource satisfies a set of rules/properties. A set of properties for the resource may include at least one of the following: A type of physical channel (e.g., PUCCH or PUSCH); A format of the physical channel (e.g., PUCCH format 1, 2, etc.); A subcarrier spacing; A duration; A number of resource blocks; A scheduling method of the resource (e.g., dynamic grant, configured grant type 1, type 2); A serving cell; A frequency band or carrier; A semi-statically configured aspect (e.g., a configured grant identity); A physical layer priority index; and/or, whether the resource is in an uplink slot or in the uplink sub-band of a sub-band full duplex slot

For example, a resource restriction applicable to a UCI instance may be that the resource is PUSCH only, and/or that the resource has a physical layer priority index of a certain value (e.g., one), and so on.

The applicability of a resource restriction may depend on the SEU on which the UCI instance would be multiplexed. For example, a resource restriction may be applicable only in case the UCI instance would be multiplexed in a transport block encoded in the resource.

A set of resource restrictions may be configured for UCI instances of a certain UCI priority, UCI type, UCI process and/or associated with certain a set of SEU. The WTRU may receive the applicable configurations by control signaling (e.g., DCI, MAC, or RRC signaling).

A WTRU may determine the set of UCI instances for which multiplexing on the resource is allowed according to the applicable resource restrictions. The WTRU may further determine the set of UCI instances for which multiplexing is possible on at least one SEU of the resource. The WTRU may select a UCI instance from this set.

For a UCI transmission, UCI may be multiplexed, and an SEU may need to be selected. A WTRU may transmit UCI in an uplink resource according to one or more approaches described herein.

In a first case, the WTRU may select at least one SEU and encode one or more UCI instances in each SEU. For example, the WTRU may encode first and second UCI instances in first SEU and third UCI instance in second SEU. In some instances, the WTRU may then proceed with further physical layer processing specific to the type of physical uplink channel of the uplink resource and transmit on the uplink resource.

In a second case, the WTRU may first multiplex one or more UCI instances in a MAC PDU or transport block. The WTRU may also multiplex data from higher layers (e.g., MAC SDUs) in the transport block, subject to multiplexing restrictions. The WTRU may encode the transport block in an SEU. In some instances, the WTRU may then proceed with further physical layer processing specific to the type of physical uplink channel of the uplink resource and transmit on the uplink resource.

A WTRU may determine at least one SEU for more than one UCI instance selected according to one or more approaches described herein. The WTRU may allocate resources sequentially to each UCI instance. The allocation order may depend on at least one of the priority, UCI type, UCI process, and/or associated time of each UCI instance. For example, the WTRU may allocate resources first to UCI instances of a highest priority, second by order of UCI process or type, and/or third by order of associated time (e.g., earliest associated time may have higher or lower priority).

If a UCI instance is associated with multiple priority levels, such as a CSI report where each component may have a different associated priority level, the WTRU may allocate resources to the whole UCI instance based on its highest priority level. Alternatively, the WTRU may allocate resources separately to each component that is associated with a different priority level.

A WTRU may determine an SEU for the transmission of a UCI instance based on a SEU identity assigned to that UCI instance.

A WTRU may determine an SEU for the transmission of a UCI instance based on a corresponding UCI type. For example, a UCI instance for HARQ-ACK may be in a first SEU, a UCI instance for CSI may be in a second SEU, and so on.

A WTRU may determine an SEU for the transmission of a UCI instance based on its assigned UCI process or SEU identity. For example, a UCI instance assigned to a first (second) UCI process may be in a first (second) SEU.

The association between a UCI type and a SEU, or between a UCI process and a SEU may be pre-defined/configured and/or signaled. For example, the indication may be in a DCI scheduling the uplink resource, or from MAC or RRC signaling.

A WTRU may determine at least one SEU for the transmission of UCI instance(s) on an uplink resource based on indication(s) from the network, such as from DCI, MAC, signaling or RRC configuration.

For example, the DCI scheduling the uplink resource may contain an indication of whether the WTRU multiplexes selected UCI instances in a MAC PDU or encodes the UCI instances in one or more SEU. In the latter case, each selected UCI instance may be encoded in a SEU based on its UCI type, on its assigned UCI process, and/or on its assigned SEU identity.

A WTRU may determine an SEU for the transmission of a UCI instance based on the payload of the UCI instance and the remaining available payload of the SEU. A remaining available payload of an SEU may be the maximum payload of the SEU, minus the payload from the UCI instances already allocated for the SEU.

For example, the WTRU may allocate a UCI instance to a first SEU if the remaining available payload of a first SEU is larger than the payload of the UCI instance. Otherwise, the WTRU may allocate the UCI instance to a second SEU if the remaining available payload of the second SEU is larger than the payload of the UCI instance. The WTRU may determine the identity of a first and second SEU applicable to the UCI instance based on a priority order of SEUs. For example, the WTRU may prioritize a first SEU (e.g., a SEU for encoding UCI only) if the UCI instance can be allocated to the first SEU, and otherwise multiplex the UCI instance with MAC SDUs in a transport block for transmission of a second SEU (e.g., a SEU for encoding a transport block).

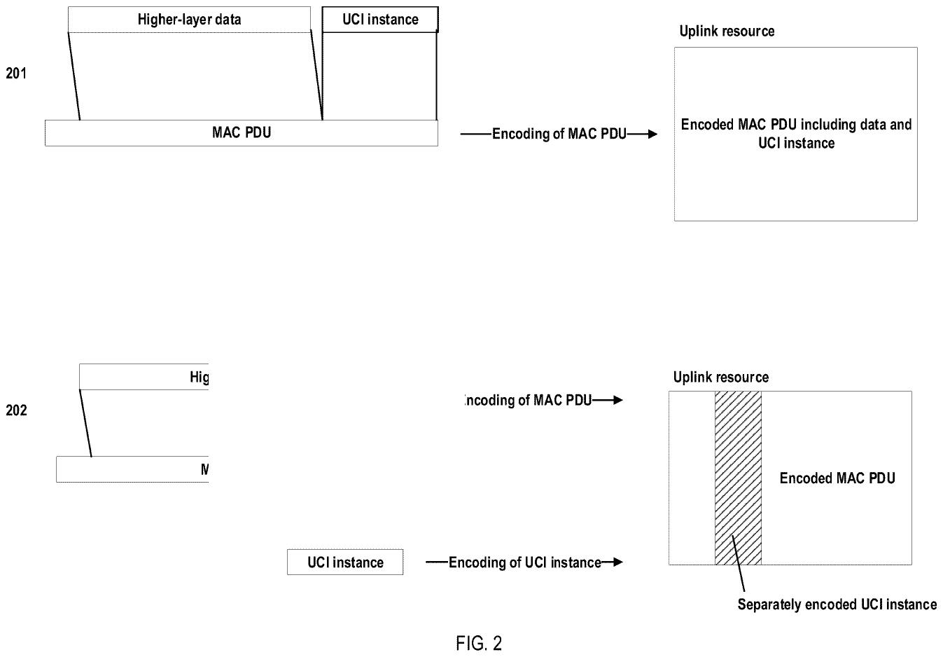

FIG. 2 illustrates an example of different encoding approaches. At 201, there is an example where a UCI instance may be jointly encoded with data, such as multiplexed. For example, within one MAC PDU, there may be a UCI instance and higher layer data, which may be multiplexed into an uplink resource for transmission. At 202, there is an e

A WTRU may determine an SEU for the transmission of a UCI instance based on a time aspect as described herein, such as an associated time or a deadline.

For example, the WTRU may select an SEU for multiplexing in a transport block if the time of the uplink resource is not later than the deadline applicable to the UCI instance minus a time offset. The value of the time offset may be configured by higher layers and/or indicated by the network. Otherwise, the WTRU may select an SEU for transmission of UCI only.

A WTRU may determine at least one multiplexing restriction for a UCI instance, wherein the UCI instance cannot be multiplexed with certain data or certain other UCI instance(s) in the same SEU.

For example, a multiplexing restriction may be that the UCI instance cannot be multiplexed with higher layer data (e.g., MAC SDU) in the same SEU.

A multiplexing restriction may depend on a priority level. For example, a restriction may be that the UCI instance cannot be multiplexed with higher-layer data and/or other UCI instances of higher priority (or lower priority) than the UCI instance, and/or of higher priority than a threshold.

A multiplexing restriction may depend on a UCI type or process. For example, a restriction may be that the UCI instance cannot be multiplexed with a UCI instance that is for a different UCI type, and/or for a different UCI process.

The WTRU may determine whether an SEU is restricted based on the multiplexing restriction(s) applicable to the UCI instance and the set of UCI instances and/or higher-layer data already allocated to the SEU. A UCI instance may also be configured with a set of restricted SEUs (or a set of allowed SEUs).

The WTRU may select an SEU from a set of SEUs that are not restricted.

A WTRU may store one or more UCI instances encoded in an SEU in a HARQ entity for a HARQ process. The WTRU may receive the HARQ process identity from a DCI or from a higher layer configuration.

Alternatively, the WTRU may determine a HARQ process identity based on one or more of the following: a UCI type, UCI priority level, and/or UCI process identity. In one case, a HARQ process identity applicable to UCI may be identical to a UCI process identity.

The WTRU may operate a HARQ entity for UCI using a similar/same approach as a HARQ entity for retransmissions of transport blocks. The WTRU may flush the HARQ process when a timer expires or when an applicable new data indicator (NDI) flips value.

The WTRU may determine to flush a HARQ process even if NDI indicated by the network is not flipped if a condition occurs. For example, if the deadline applicable to a UCI instance has passed or if a maximum number of retransmissions applicable to the UCI instance has been reached. The WTRU may indicate that the transmission contains new data by transmitting a flipped NDI value applicable to the SEU. The transmission may be within the same uplink resource in a separate SEU or in a different uplink resource.

In some cases, as part of the UCI transmission process, one or more resources need to be selected. A WTRU may select a resource that allows transmission of a highest priority UCI instance and/or data.

A WTRU may receive signaling indicating a set of resources (e.g., one or more), such as more than one resource wherein only one of the more than one resources can be used for transmission. For example, the WTRU may first receive signaling for a first periodic or semi-persistent resource (e.g., by RRC or MAC), and then receive dynamic signaling for a second resource, wherein only one of the first and second resource may overlap in time domain at least within the same carrier.

The WTRU may select a resource from the more than one resource based on one or more of the following criteria: Resource allowing transmission of largest payload of UCI instances of highest priority, or of largest payload of UCI instances and higher-layer data of highest priority; Resource with earliest last time symbol; Resource with highest physical layer priority index; Type of physical channel (e.g., PUSCH may have priority over PUCCH); A format of the physical channel; A number of available SEU's for the resource; A subcarrier spacing, duration, number of resource blocks; A scheduling method of the resource (e.g., dynamic grant may have priority over configured grant type 1, type 2); A serving cell, a frequency band, or carrier; A semi-statically configured priority for the purpose of resource selection; whether the resource is in an uplink slot or in the uplink sub-band of a sub-band full duplex slot; and/or, the priority of the UCI or data for which the resource was indicated (e.g., the WTRU may select the resource that was indicated by a DCI triggering calculation of a UCI instance of highest priority).

A WTRU may receive signaling for a resource with an indication that it supports UCI scheduling as described herein. The WTRU may also receive signaling for resources that may support UCI transmission according to a first system procedure. Such a resource may be indicated by a DCI that triggers generation of a UCI instance (e.g., a DCI scheduling PDSCH or PUSCH with A-CSI request).

In an approach, the WTRU may transmit UCI using a resource signaled according to the first system procedure (e.g., a “first resource” if a set of conditions is satisfied). The set of conditions may include one or more of: the resource signaled according to the first system procedure that does not conflict with any other resource (e.g., no time overlap within a carrier); and/or at a reference time, a resource supporting UCI scheduling is not available or is not available before a deadline.

The reference time may be the transmission time of the first resource minus a time offset. The deadline for the resource supporting UCI may correspond to the deadline of the UCI instance that would be transmitted using the first resource.

If the set of conditions is not satisfied, the WTRU may not use the first resource and may store the UCI in a UCI entity for transmission using techniques described herein.

A WTRU may receive an indication or configuration for a resource supporting UCI scheduling for more than one allowed set of SEUs or “SEU format”. For example, a first allowed set of SEUs may correspond to a single (or two, etc.) SEUs for transmission of transport block(s) that may include data. A second allowed set of SEUs may correspond to SEUs for transmission of transport block(s) with the addition of one SEU for the transmission of UCI only.

The WTRU may select an SEU format based on one or more of the following: SEU format that maximizes transmission of payload of UCI instances and/or data of highest priority; and/or, if multiple SEU formats can maximize transmission of highest priority UCI instances and/or data, select SEU format with smallest number of SEUs.

In another approach, the WTRU may select a SEU format that corresponds to only SEUs supporting transmission of transport block(s) that may include data, unless at least one UCI instance available for transmission is restricted from using such SEUs.

The WTRU may indicate the selected SEU format and associated SEU information within the uplink resource (e.g., possibly within a SEU format reserved for this purpose) or in a separate resource associated with the uplink resource.

A WTRU may be configured to transmit information on the availability of applicable UCI instances. The WTRU may transmit the information on a buffer status report (BSR), a UCI status report (USR), or some other message. The information may include one or more of, but not limited to, the following for at least one applicable UCI instance: Type of UCI (e.g., CSI, HARQ feedback, etc.); Number of UCI instances; Available payload of each UCI instance, combined payload, or a range of payload; and/or, at least one property associated to each of the applicable UCI instances, such as priority level, UCI process, set of allowed SEU's, multiplexing restrictions, maximum number of retransmissions, and/or deadline (e.g., possibly as a difference from a reference time, e.g., timing of the uplink resource). As disclosed herein, triggering may refer to an instance where the UCI needs to be generated, additionally/alternatively triggering may refer to an instance where the UCI is transmitted; triggering may be based on a determination made by the WTRU, and/or may be made based on an indication sent from the network.

The WTRU may trigger reporting using one or more techniques, such as where the payload of the UCI instance is considered as data available for transmission with the priority level assigned to the UCI instance. Alternatively, a BSR/USR for UCI may be triggered independently from a (e.g., regular) BSR for data. For example, the WTRU may trigger the reporting procedure if no UL resources are available to report at least part of the UCI. In another example, there may be UL resources available for the WTRU but they are time threshold away, where the time threshold may be the deadline to transmit the UCI; and/or there may be UL resources that may not be able to carry UCI (e.g., restrictions to map UCI to a grant-like a configured grant). For example, the WTRU may send a BSR, SR, or random access (e.g., as an initial step in a process for generating/sending UCI). For example, there may be enough resources available for the BSR (or USR) but not for the whole payload of an available UCI. There is also a possibility that there is no resource for BSR, in which case the WTRU may initiate scheduling request procedure (e.g., this could be a RACH procedure or a resource for 1-2 bits that is always allocated)

The WTRU may trigger reporting if an applicable UCI instance associated with a deadline becomes available, or if a time difference between the deadline and a reference time is lower than a threshold. The WTRU may trigger reporting if no reporting is already triggered or higher priority UCI instance than reported earlier becomes available in the buffer.

The WTRU may multiplex UCI instances into the transmission containing the BSR, such as a UCI instance consisting of CSI information. The BSR itself may be transmitted as a UCI instance. The BSR/USR may be cancelled if all the UCI available to be reported can be multiplexed/transmitted in the same transmission that would carry the corresponding BSR/USR. For example, if the UCI payload is so small that it can fit in an already available resource, then may not be preferable to send a BSR to request additional resources; this determination may be configured.

In case no resource is available for the transmission of the BSR, the WTRU may initiate a scheduling request procedure. A scheduling request (SR) configuration (e.g., including resource configuration) applicable to UCI instances may depend on the priority level and may be independently configured from the scheduling request configuration to which a logical channel or QoS flow is mapped. In one example, one or more separate SR configuration(s) may be associated with requesting resources for UCI reporting. For example, a SR configuration may be associated with a type of UCI; or based on the UCI deadline; or based on the type of resources to be requested (e.g., PUCCH or PUSCH). In one example, such SR resource(s) may or may not be applicable to request UL resources for other purposes (e.g., data). In one example, if no SR resources are assigned for requesting resources for UCI, the WTRU may trigger a Random Access procedure.

The WTRU may initiate a contention-based procedure where BSR/USR is included in initial messages if no resource is available.

A WTRU may cancel transmission on a first uplink resource and/or cancel repetitions if an applicable UCI instance becomes available. The WTRU may then initiate transmission of a scheduling request and/or BSR and/or the applicable UCI instance on a second resource. The second resource may be configured for the purpose of pre-emption, possibly as part of configuration for a UCI priority level or UCI process that supports pre-emption. As described herein, pre-emption may mean that it can interrupt an on-going transmission (e.g., lower priority transmission) instead of waiting for it to be completed.

For example, a WTRU may trigger the generation of a UCI instance including a mobility measurement report (e.g., L1-RSRP) based on a certain event (e.g., indicating cell switch). Such a report may be configured to support pre-emption. The WTRU may cancel an on-going transmission on a first resource (or repetitions thereof) to transmit the report on the second resource.

In some cases, a WTRU may be configured or predefined with UCI instance transmission type condition, whereby if one or more conditions is met/not met, the WTRU may transmit the UCI instance on a given uplink resource type (e.g., on PUSCH, as information part of a MAC PDU/TB payload, or on a given SEU type). If one or more conditions is met/not met, the WTRU may transmit the UCI instance on a different uplink resource type (e.g., on PUCCH, or per the legacy UCI transmission mechanism). A UCI instance transmission type condition may include one or more conditions, as disclosed herein.

An example condition may be a function of the UCI instance/type being from a given type (e.g., HARQ feedback, CSI, etc.)

An example condition may be a function of reliability and/or priority associated with the UCI instance. For example, the WTRU may transmit the UCI instance part of a TB payload (e.g., as part of a MAC PDU) if the UCI instance priority is of a priority higher than a configured threshold. In one example, if the UCI instance is related to data or a HARQ process configured from a subset of channels and/or HARQ processes, the WTRU may consider the UCI instance as transmitted with a given priority or reliability level.

An example condition may be a function of the type of other data multiplexed on the same transmission. For example, the WTRU may be configured or predefined with exclusion conditions, such that if a given UCI instance/type is multiplexed, the WTRU doesn't multiplex data from a given type or a given bearer/LCH. The WTRU may be configured or predefined with exclusion conditions, such that if a data from a given type (e.g., SRB data or MAC CEs of a given type), bearer, priority (e.g., priority >threshold) is multiplexed, the WTRU does not multiplex one or more UCI instances, possibly from given UCI type(s). A data type may refer to data of being control data (e.g., SRB data, MAC CE), user plane data, sensing data, machine learning data, system data, etc.

An example condition may be a remaining time associated with the UCI instance, as explained herein, being less than-or greater than-a threshold.

An example condition may be a DL signaling is received from the network indicating a given transmission type or a physical uplink resource associated with the UCI instance or type.

An example condition may be where network load congestion is not present or below a threshold. The WTRU may transmit UCI an instance using one transmission type or on a certain resource type if congestion is not determined/detected, whereby the WTRU may determine the congestion level from NW signaling (e.g., broadcast or dedicated-MAC or DCI-signaling).

An example condition may be where a WTRU determines the serving cell is in a given network energy saving state (e.g., reduced time, frequency, power, or spatial domain activity, reduced broadcast activity, or cell DTX/DRX). The WTRU may transmit DP data if the network is not determined to be a network energy saving, whereby the WTRU may determine the NES state from network signaling (e.g., broadcast or dedicated-MAC or DCI-signaling) or from the periodicity of broadcasted common signals/channels.

An example condition may be where a WTRU is in a power saving state. The WTRU may transmit a UCI instance while C-DRX is not activated, during the active period of C-DRX, or cell DTX, or during configured periods that occur periodically. For example, during a “UCI transmission window” that occurs periodically, the WTRU may transmit UCI using a given transmission type or a certain uplink resource type.

An example condition may concern a WTRU CPU load or processing state. The WTRU may transmit UCI instance/type only in a subset of WTRU states (e.g., while the WTRU is not overheating, available memory >threshold, or CPU consumption is less than a threshold).

An example condition may be a measured channel condition being larger-or lower than-than a configured threshold. For example, a UCI instance may be transmitted using a given transmission type or on a given physical uplink resource type only if the power headroom is below-or above-a given threshold (e.g., is a positive value), or if the WTRU measures RSRP or a metric related to UL and/or DL coverage being better than a configured threshold.

An example condition may be a function of the amount of other buffered data and LCP. For example, the WTRU may transmit UCI instances/types if buffered data from other DRBs, SRBs, and/or MAC CEs is less than a threshold or not buffered/triggered for transmission/multiplexing. In one example, the WTRU may multiplex a given UCI instance on a given uplink resource only in the second round of LCP resource allocation (e.g., after allocation of data up to prioritized bit rate(PBR) PBR). The WTRU may multiplex UCI instances, possibly from a subset of types, only if padding bits remain and the size of the UCI instance is <the number of padding bits (e.g., the number of bits remaining in the grant after multiplexing other data). The WTRU may be configured or predefined to allow the multiplexing of certain UCI instances/types in round 1 and/or round 2 of LCP.

An example condition may be a function of whether PUCCH resources overlap with PUSCH resources. If no overlap occurs, the WTRU may transmit UCI using a given transmission type or a physical uplink resource type (e.g., legacy on the PUCCH). If overlap occurs, the WTRU may select/prioritize a transmission type (e.g., PUSCH) and instead of multiplexing the UCI corresponding to the other transmissions, store the UCI and rely on the techniques disclosed herein for transmitting that UCI.

An example condition may be a function of the time of the next PUCCH resource, such as being less than or below a threshold, where the threshold may be configured or determined from a timeline associated with the UCI instance (as described herein).

An example condition may be where the WTRU may be configured or defined with triggering and cancellation procedures for the transmission of UCI instances, possibly per UCI type. The WTRU may keep multiplexing the UCI instance for transmission until cancelled. The WTRU may cancel the transmission of a given UCI instance/type upon transmitting the UCI instance, receiving an acknowledgement from the network (e.g., an ACK) to the transmission on which the UCI was multiplexed or transmitted, expiry of a timer associated with the UCI instance or the UCI type, and/or receiving an uplink grant or a DCI. A UCI type may remain pending for transmission until cancelled.

In some cases, properties may be assigned to a UCI instance, such as, but not limited to, one or more of the following: At least one priority level; A UCI process; A set of allowable SEUs; A resolution level or UCI format; A deadline; Multiplexing restrictions; Resource restrictions; Whether it is applicable to buffer status reporting (BSR) when available; and/or, a Maximum number of retransmissions.

A WTRU may assign a property to a UCI instance based on an indication or signaling related to the generation of the UCI instance. For example, a priority level or a process identifier may be indicated in a DCI triggering a CSI calculation or scheduling a PDSCH, and the WTRU assigns such in corresponding UCI instance (e.g., CSI instance or HARQ-ACK).

The WTRU may assign a property to a UCI instance based on an event triggering the calculation of the UCI instance, such as a cell switch, data arrival, bandwidth part switching, beam failure recovery, and/or the like. For example, the WTRU may assign a highest priority level or a certain UCI process to a UCI instance consisting of CSI triggered by cell switch, data arrival, and/or other events.

The WTRU may assign a property to a UCI instance based on a corresponding property of a resource related or used in the calculation of a UCI instance. For example, if a PDSCH is assigned a priority level, corresponding downlink decoding information (e.g., HARQ-ACK) may be assigned same priority level.

For example, a priority level may be configured as part of a CSI report configuration.

For example, resource restrictions and/or multiplexing restrictions may be configured as part of a CSI report configuration or as part of a configuration for HARQ-ACK reporting.

At least one of resource restrictions, multiplexing restrictions, SEU restriction, applicability to BSR reporting, and maximum number of retransmissions may be configured by higher layers to be associated with a UCI instance according to one or more of: the UCI instance priority level (or highest priority level); the UCI process assigned to the UCI instance; and/or, the UCI type of the UCI instance.

For example, the WTRU may receive configuration indicating that UCI instances associated with a first UCI process (or UCI type, or UCI priority level) are allowed to be transmitted using a SEU that encodes a transport block that may include data, while UCI instances associated with a second UCI process (or UCI type, or UCI priority level) are not allowed to be transmitted using such SEU.

A WTRU may assign a property to a UCI instance based on a time aspect such as the timing of a resource used for the calculation of the UCI (e.g., a CSI-RS resource or a PDSCH) or an applicable time for the UCI (e.g., timing of a CSI reference resource, applicable time of predicted CSI).

For example, the WTRU may assign a first (e.g., higher) priority level if the time difference between a reference time and such applicable time is lower than a threshold, and a second (e.g., lower) priority level if the time difference is higher than a threshold. A reference time may be a time when the property determination is made (e.g., the current time), the time of the uplink resource that would encode the UCI instances (e.g., a first symbol of the uplink resource) or a time of the transmission scheduling it (e.g., a last symbol of the scheduling PDCCH). If the UCI instance is associated to multiple priority levels, the value of the time difference threshold may depend on the component. For example, for a CSI report comprised of multiple components, the time difference threshold of a component representing more dynamically changing conditions (e.g., a Precoding matrix indicator or PMI) may be configured to a smaller value than the threshold of other components (e.g., a rank indicator or RI).

For example, the WTRU may assign a resolution level or UCI format to a UCI instance. A UCI format applicable to a UCI instance may determine a number of information bits (or resolution level) representing the result. For example, a CSI report may include a co-phasing indicator or matrix with a certain resolution. For a first, second and third UCI format, the co-phasing indicator may have a resolution of 2 bits, 1 bit and 0 bit respectively (0 bit means that the co-phasing indicator is absent). The WTRU may assign first UCI format when a time difference is below a first threshold, a second UCI format when a time difference is below a first threshold and above or equal to a second threshold, and a third UCI format if the time difference is above a second threshold. The time difference may be the reference time minus the CSI reference time for the CSI report. This solution may have the benefit of saving overhead when the UCI instance corresponds to a measurement that may no longer be valid due to time.

A WTRU may assign a property to a UCI instance based on a value or contents associated to the UCI instance.

For example, the WTRU may assign a priority level to a UCI instance consisting of a L1-RSRP report that depends on the last reported L1-RSRP. For example, the WTRU may assign a first (high) priority level if the difference (e.g., in absolute value) is higher than a threshold, and a second (low) priority level if the difference is lower than a threshold.

For example, the WTRU may assign a priority level to a UCI instance consisting of a power headroom report (PHR). The WTRU may assign a first (high) priority level if the power headroom is lower than a threshold, and a second (low) priority level if the difference is higher than a threshold.

For example, the WTRU may assign a first (high) priority level to a UCI instance consisting of HARQ-ACK if the HARQ-ACK value is NACK and possibly if the corresponding PDSCH is also indicated with high priority. The WTRU may assign a second (low) priority level otherwise.

For example, the WTRU may assign a priority level to a UCI instance consisting of a buffer status report to the highest priority level among UCI instances and/or MAC SDUs (or logical channels, or QoS flows) that have data available for transmission.

In the examples herein, a value or threshold may be signaled by DCI, MAC, or configured by RRC.

Any transmission from the network may server as a trigger, such as, but not limited to, DCI, MAC, RRC, downlink transmission, data transmission, control transmission, etc.

In some instances, for the “triggering”, there may be in fact two triggers. There may be first trigger is for the WTRU to start generating the UCI. The second trigger may be for the WTRU to initiate reporting of the UCI. The first and/or the second trigger may be from a network indication (e.g., but not necessarily). Triggers may be depending on UCI type, as disclosed herein.

In one example, there may be a method performed by one or more processors and transceivers of a WTRU, where the processor and transceiver are operatively connected. The WTRU (e.g., the processor and/or transceiver that is configured to perform one or more steps) may select what UCI to transmit in a resource and determine whether to jointly or separately encode the UCI with data as a function of control information, such as downlink control indication associated to the resource, priorities associated to UCI, data, resource, maximum latency and/or other factors.

Before, and/or at any point during the process, another entity (e.g., a base station, other network entity, other WTRU) may send configuration information indication one or more relevant pieces of information for the UCI transmission process. The configuration information may be provided in advance or at the time of triggering the UCI.

The WTRU may generate UCI (e.g., either triggered by network message and/or determined to do so by the WTRU). The UCI may include one or more UCI instances. For example, the UCI instance may be one or more of, but not limited to, the following: explicit indication or measurement event triggers calculation of CSI; reception of PDSCH triggers calculation of HARQ-ACK; and/or, reception of uplink grant triggers calculation of power headroom report (PHR).

The WTRU may assign properties to at least one UCI instance, as a function of UCI type, explicit indication, configuration, and/or the like. For example, the properties may be one or more of, but not limited to, the following: Priority level; Deadline; Restriction on resource; Restriction on multiplexing with other UCI and/or data; and/or, UCI process identity.

The WTRU may determine if a resource is available for new transmission of UCI. The WTRU may (e.g., subsequently) may perform one or more actions thereafter. The WTRU may determine set of UCI instances that can be multiplexed in the resource based on assigned restriction, priority, and/or downlink control information. The WTRU may determine how each UCI instance is multiplexed in the resource from the following options, based on explicit indication and/or UCI property (e.g., separately encoded in portions of the resource (as in legacy); e.g., multiplexed (e.g. as MAC CE) into a MAC PDU delivered to a HARQ process indicated with the resource, subject to multiplexing restrictions with data). The WTRU may encode and multiplex the UCI in the resource. The WTRU may transmit using the resource.

The WTRU may determine if a resource is not available for new transmission of UCI. The WTRU may (e.g., subsequently) may perform one or more actions thereafter. The WTRU may initiate transmission a procedure to request resource for UCI.

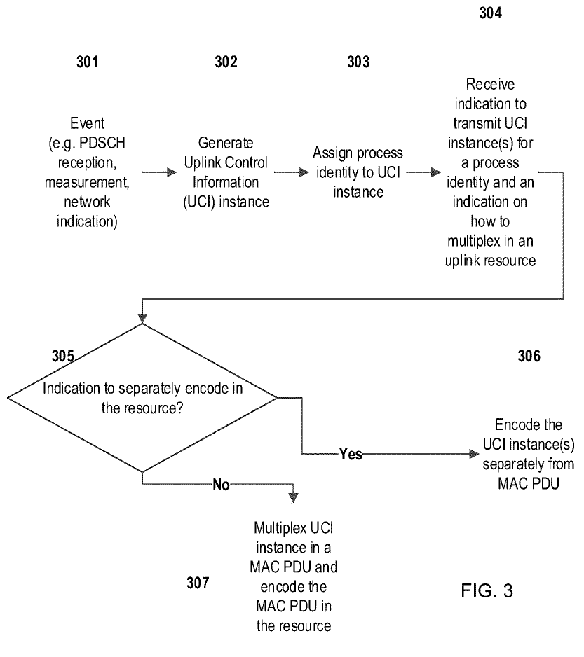

FIG. 3 illustrates an example process of sending UCI. At 301, there may be some event, such as a PDSCH reception, measurement, and/or a network indication. At 302, a WTRU may generate a UCI instance (e.g., based on the event, which in this case is acting like a trigger). At 303, the WTRU may assign an identity to the UCI instance (e.g., this process is applicable to more than one UCI instance). At 304, the WTRU may receive an indication to transmit one or more generated UCI instances given a specific property of the UCI instance, such as the process identity; the indication may also include information on how/whether to encode (e.g., multiplexing in an uplink resource, encoding separately, etc.). At 305, the indication is processed, and if the WTRU determines to encode separately, then the process proceeds to 306, but if the WTRU determines to encode jointly, then the process proceeds to 307, multiplexing the UCI instance in a MAC PDU and encoding the PDU in the resource. The techniques/approaches of this example are applicable to all that is disclosed herein. Subsequently, the WTRU would transmit the UCI, in whatever form it is previously determined.

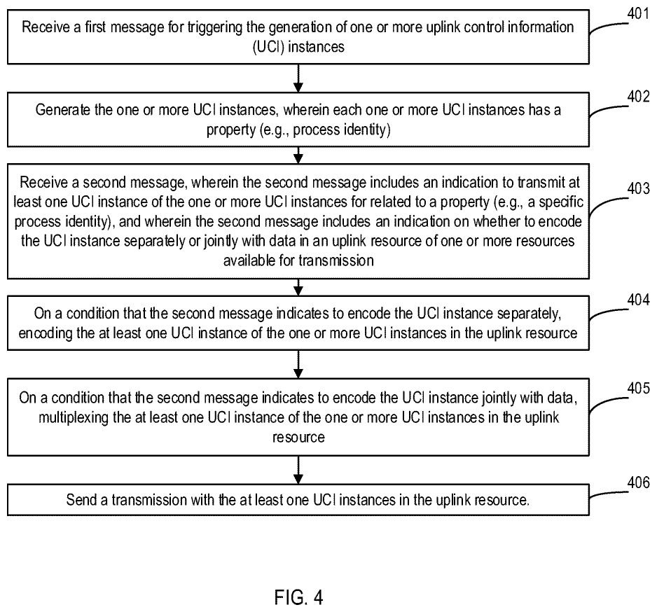

FIG. 4 illustrates an example process of sending UCI. At 401, a wireless transmit receive unit (WTRU), may perform a method. The WTRU may (e.g., via a processor operatively connected to a transceiver) receive a first message that includes information related to UCI, including an information that triggers, or provides the configuration for, the generation of one or more uplink control information (UCI) instances. At 402, the WTRU may generate the one or more UCI instances, wherein each one or more UCI instances has a property, as described herein (e.g., a process identity in this example). The first message may be a control message, as described herein. At 403, the WTRU may receive a second message, wherein the second message may include an indication to transmit at least one UCI instance of the one or more UCI instances for a process identity, and wherein the second message may include an indication on whether to encode the UCI instance separately or jointly with data in an uplink resource of one or more resources available for transmission. In some instances, the indication may be configuration. At 404, on a condition that the second message indicates to encode the UCI instance separately, the WTRU may encode the at least one UCI instance of the one or more UCI instances in the uplink resource. At 405, on a condition that the second message indicates to encode the UCI instance jointly with data, the WTRU may multiplex the at least one UCI instance of the one or more UCI instances in the uplink resource. At 406, the WTRU may send a transmission with the at least one UCI instances in the uplink resource. In some instances, the UCI instance is based on HARQ-ACK, power headroom report (PHR), or channel state information (CSI). In some instances, the UCI instance is triggered by a measurement performed by the WTRU, reception of a message that requires HARQ-ACK feedback, or an indication form a network. In some instances, a UCI instance may have at least one property includes priority level, deadline, restriction on resource, restriction on multiplexing, or a UCI process identity. In some instances, the one or more UCI instances includes the at least one UCI instance and a second UCI instance, wherein the second UCI instance is not multiplexed based on an associated time factor. In some instances, the one or more UCI instances includes the at least one UCI instance and a second UCI instance, wherein the second UCI instance is encoded separate from the at least one UCI instance based on a UCI type of the second UCI. In some instances, a configuration message is received prior to the first message, wherein the control message includes one or more properties associated with UCI.

In one example, Uplink Control Information (UCI) may be generated in one or more instances whenever specific triggers occur. For example, an explicit indication or a measurement event can prompt the calculation of Channel State Information (CSI), the reception of a Physical Downlink Shared Channel (PDSCH) can trigger a Hybrid Automatic Repeat Request Acknowledgment (HARQ-ACK), and receiving an uplink grant can prompt a Power Headroom Report (PHR). Once UCI instances are generated, each instance can be assigned various properties—such as a priority level, a deadline, restrictions on the resource to be used, restrictions on multiplexing with other UCI or data, and a unique UCI process identity—based on factors like UCI type, explicit indication, or configuration. If a resource is available for new transmission of UCI, the system determines which UCI instances can be multiplexed in that resource by considering their assigned restrictions, priorities, and any relevant downlink control information. It then decides how each UCI instance should be multiplexed. Options include encoding them separately in distinct portions of the resource, or multiplexing (e.g., encoding jointly) them—potentially as a MAC Control Element (MAC CE)—into a MAC Protocol Data Unit (MAC PDU) delivered to a specific HARQ process, subject to multiplexing restrictions with data. After deciding the multiplexing strategy, the UCI is encoded and sent using the available resource. In contrast, if no resource is available for new UCI transmission, the system initiates a procedure to request a suitable resource for transmitting the UCI.

As described herein, signaling may refer to one or more messages sent to indicate one or more pieces of relevant information, such as configuration information.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein. In one example, a base station may be distributed (e.g., different units that address or include different functions/layers/protocols/hardware/etc.; a first unit, second unit, etc.).

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, “at least one of” may be interchangeable with “one or more of”.

As described herein, reference of a configuration may mean that at some point a WTRU may receive a message that includes configuration information. In one instance, the WTRU may provide feedback after having received it. In one instance, the WTRU may request the message. In one instance, the message may be unrequested.

What is claimed:

1. A method performed by a wireless transmit receive unit (WTRU), the method comprising:
receiving a first message for triggering the generation of one or more uplink control information (UCI) instances;
generating, based on the first message, the one or more UCI instances, wherein each one or more UCI instances has a process identity;
receiving a second message, wherein the second message includes an indication to transmit at least one UCI instance of the one or more UCI instances for a process identity, and wherein the second message includes an indication on whether to encode the UCI instance separately or jointly with data in an uplink resource of one or more resources available for transmission;
on a condition that the second message indicates to encode the UCI instance separately, encoding the at least one UCI instance of the one or more UCI instances in the uplink resource;
on a condition that the second message indicates to encode the UCI instance jointly with data, multiplexing the at least one UCI instance of the one or more UCI instances in the uplink resource; and
sending a transmission with the at least one UCI instances in the uplink resource.

2. The method of claim 1, wherein the at least one UCI instance is based on HARQ-ACK, power headroom report (PHR), or channel state information (CSI).

3. The method of claim 2, wherein the at least one UCI instance is triggered by a measurement performed by the WTRU, reception of a message that requires HARQ-ACK feedback, or an indication form a network.

4. The method of claim 1, wherein the at least one UCI instance has at least one property including priority level, deadline, restriction on resource, restriction on multiplexing, or a UCI process identity.

5. The method of claim 1, wherein the one or more UCI instances includes the at least one UCI instance and a second UCI instance, wherein the second UCI instance is not multiplexed based on an associated time factor.

6. The method of claim 1, wherein the one or more UCI instances includes the at least one UCI instance and a second UCI instance, wherein the second UCI instance is encoded separate from the at least one UCI instance based on a UCI type of the second UCI.

7. The method of claim 1, wherein a configuration message is received prior to the first message, wherein the configuration message includes one or more properties associated with UCI.

8. wireless transmit receive unit (WTRU), the WTRU comprising:
a processor operatively coupled to a transceiver, the processor and transceiver configured to receive a first message for triggering the generation of one or more uplink control information (UCI) instances;
the processor and transceiver configured generate, based on the first message, the one or more UCI instances, wherein each one or more UCI instances has a process identity;
the processor and transceiver configured to receive a second message, wherein the second message includes an indication to transmit at least one UCI instance of the one or more UCI instances for a process identity, and wherein the second message includes an indication on whether to encode the UCI instance separately or jointly with data in an uplink resource of one or more resources available for transmission;
on a condition that the second message indicates to encode the UCI instance separately, the processor and transceiver configured to encode the at least one UCI instance of the one or more UCI instances in the uplink resource;
on a condition that the second message indicates to encode the UCI instance jointly with data, the processor and transceiver configured to multiplex the at least one UCI instance of the one or more UCI instances in the uplink resource; and
the processor and transceiver configured to send a transmission with the at least one UCI instance in the uplink resource.

9. The WTRU of claim 8, wherein the at least one UCI instance is based on HARQ-ACK, power headroom report (PHR), or channel state information (CSI).

10. The WTRU of claim 8, wherein the at least one UCI instance is triggered by a measurement performed by the WTRU, reception of a message that requires HARQ-ACK feedback, or an indication form a network.

11. The WTRU of claim 8, wherein the at least one UCI instance has at least one property including priority level, deadline, restriction on resource, restriction on multiplexing, or a UCI process identity.

12. The WTRU of claim 8, wherein the one or more UCI instances includes the at least one UCI instance and a second UCI instance, wherein the second UCI instance is not multiplexed based on an associated time factor.

13. The WTRU of claim 8, wherein the one or more UCI instances includes the at least one UCI instance and a second UCI instance, wherein the second UCI instance is encoded separate from the at least one UCI instance based on a UCI type of the second UCI.

14. The WTRU of claim 8, wherein a configuration message is received prior to the first message, wherein the configuration message includes one or more properties associated with UCI.
